(19) United States
(12) Patent Application Publication
(10) Pub. No.: US 2024/0211728 A1
(43) Pub. Date: Jun. 27, 2024

(54) Method and System of Audio Detection of a Target Audio Source in Noisy Environments

(71) Applicant: Intel Corporation, Santa Clara, CA (US)

(72) Inventors: Rita CHATTOPADHYAY, Chandler, AZ (US); Stanley MO, Portland, OR (US); Matias ALMADA, South Lake Tahoe, CA (US); Steven KREBS, Maricopa, AZ (US)

(73) Assignee: Intel Corporation, Santa Clara, CA (US)

(21) Appl. No.: 18/233,803

(22) Filed: Aug. 14, 2023

(51) Int. Cl. G06N 3/045

(52) U.S. Cl. CPC G06N 3/045

(57) ABSTRACT

A computer-implemented system, platform, device, and method of audio processing comprises receiving, by processor circuitry, a mixed audio signal having a plurality of audio sources, and separating the mixed audio signal into at least one separate target audio source signal; and determining whether or not the at least one separate target audio source signal is associated with at least one target audio source. This also comprises inputting at least one of the separate target audio source signals into a classifying neural network.

### BACKGROUND

Detection and tracking of unmanned aerial vehicles (UAVs) such as drones is often either performed to navigate the drone or to detect the drone's location. For example, such drones are used for aerial surveys, mapping, geographic information system (GIS) data collection, infrastructure inspection, construction, smart-city applications, package delivery, and military uses. Whether the drone is tracked by camera (visually), radar, tracking signals (such as global positioning systems (GPS)), and so forth, each system has its own limitations. When drones are flying low to the ground near or between structures such as buildings or trees, the structures can interfere with, or block, many of the tracking and detection systems. Thus, navigating or tracking a drone during takeoff or landing can be particularly difficult. Also, conventional audio drone tracking systems have been used to detect the propeller sounds usually emitted by drones but often have been found to be inaccurate due to background noise.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an example audio capture setup according to at least one of the implementations described herein;

FIG. 2 is a schematic diagram of an example audio processing system to perform audio detection of target audio sources in noisy environments according to at least one of the implementations described herein;

FIG. 3 is a schematic diagram of an example separation unit of the audio processing system of FIG. 2 and according to at least one of the implementations described herein;

FIG. 4 is a schematic diagram of an example source separator model of the separation unit of FIG. 3 and according to at least one of the implementations described herein;

FIG. 5 is a schematic diagram of an example classification unit of the audio processing system of FIG. 2 and according to at least one of the implementations described herein;

FIG. 6 is a flow chart of an example method of audio detection of target audio sources in noisy environments according to at least one of the implementations described herein;

FIG. 7 is a schematic diagram of an example audio detection system of target audio sources with multiple source separation units according to at least one of the implementations described herein;

FIG. 8 is a schematic diagram of an example audio detection system of target audio sources with multiple classification units according to at least one of the implementations described herein;

FIG. 9 is a schematic diagram of an example source separator neural network according to at least one of the implementations described herein;

FIG. 10 is a schematic diagram of an example classifier neural network according to at least one of the implementations described herein;

FIG. 11 is a schematic diagram of an example system;

FIG. 12 is a schematic diagram of another example system; and

FIG. 13 is an example device, all arranged in accordance with at least some of the implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as computing systems that have or receive acoustic signals from one or more microphones, but also may include servers, laptop or desktop computers, tablets, controllers for drones or any other unmanned aerial vehicles (UAVs), transport, or vehicle, smart speakers, mobile devices such as smart phones, smart watches, and/or smart headphones or head mounted displays (HMDs), internet of things (IOT) devices, video game panels or consoles, virtual, augmented, or mixed reality systems, on-board vehicle systems, security and environment control systems, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof. The terms audio and acoustic are used interchangeably herein.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical, or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, media, devices, and methods of audio detection of a target audio source in noisy environments are described herein.

Audio-based sound source discrimination (or detection of drones or unmanned aerial vehicles (UAVs)) has become very sophisticated and computation heavy, and in turn very costly, to provide a relatively high performance system. This can be very important when commercial or government drones are used in time-sensitive situations and fast interpretation of data and drone positions are needed to protect human life or property, such as with storm surveillance, emergency response events, or military uses.

Most conventional audio-based drone tracking systems, however, use a single stage pipeline with an audio machine learning or deep learning neural network model trained to detect a drone's audible artifacts amidst a wide variety of background noises which may include traffic or vehicle horns, a child crying, wind sounds, helicopter sounds, a dog's bark, and so forth. To achieve this, the known single stage audio model is trained with ideal or pure separate sounds of each different background noise. In a run-time, the audio model receives a recorded mixed signal and then attempts to detect acoustics of a drone within that mixed signal.

Sounds in real life, however, are not pure ideal signals. Microphones record multiple sound sources simultaneously, which contaminates the audio signals of different sounds at a receiver, thereby making it very difficult to detect a single target source such as a drone from a mixture of signals. Therefore typically, such conventional audio models are inaccurate because they are not trained with real world audio signals needed for high accuracy detection of a drone.

The conventional audio model becomes even more inaccurate with the increase in variety of the background noises. Such background noise may vary depending on location, such as rural, suburb, urban, forest, mountains, desert, at sea, sea shore, military zone, and so forth, as well as time of the day, weather conditions, season, and so forth. Hence, training a model with pure signals and deploying it to identify a drone signature in real time, and with contaminated varied background noise, does not provide sufficient drone detection accuracy.

To resolve these issues, a method and system of audio detection of a target audio source includes a two stage approach that first separates audio signals from a mixed audio signal, and then classifies one or more of the separated audio signals (or more precisely, separate source audio signal data) to determine if at least one of the audio sources contributing to the mixed audio signal is a target audio source, such as a drone. A separator model (or just separator) in a first stage before a second stage classifier model (or just classifier) can filter out a target sound signature from background audio signals, thereby providing a target audio signal with significantly reduced background noise to a second stage classifier. By one form, the separator model provides just a target audio signal to the classifier model. By other forms, the separator model provides separate target and background audio signals. By some forms, the separator model only provides the separated background audio signals during training but not during a run-time. The result is a large increase in the accuracy of the classifier. By one form, the separator and classifier are both deep learning (DL) neural networks (NNs) described herein, but may be, or use, other non-neural network machine learning (ML) algorithms.

The present separator model can be trained by using any background noises and the background noise (or background audio signals) for training do not need to have signatures with specific recognizable features of repeating audio source signal patterns (or repetition in an audio source signal pattern). Particularly, conventional separators are often used for musical analysis and enhancement by separating an input mixed musical signal into separate musical instrument and human voice signals, and/or into separate audios signals by musical instrument. Some known separators assume that background is white noise for training such a musical separator ML or DL model. Other conventional neural network music separators assume that the background is repetitive. Specifically, a REpeating Pattern Extraction Technique (REPET) is a source separation algorithm that separates a repeating “background” from a non-repeating “foreground”. REPET finds the repeating period in an audio signal, slices the signal into “frames” of the same length of the repeating period, and “overlays” those frames. Once the frames are overlaid, REPET extracts the non-repeating part of a signal by filtering out values that are far from the median value at each frame. Thus, this assumes a certain characteristic of the background noise, which does not work when identifying random sound signals that may have little repetition in audio signal ptterns in an extremely wide variety of background such as sounds from vehicles, wind or other weather sound, a dog's bark, birds chirping, baby crying, machine sounds, etc. In more detail, repetitive refers to usually conventional digital signal processor (DSP) based sound separation models that are arranged to separate human voice from sounds of instruments in a song. Since the instrument sounds are repetitive in nature such as with a beat or melody, these conventional models use the repetitive characteristics to detect and remove the instrument sounds. However, for general (non-song or non-music piece) applications, the background sounds are not so clearly repetitive in nature, hence these models do not perform well for such applications.

Instead, however, and by one form, the present method and system does not assume any specific characteristics of the background noise, and can be trained on a large variety of just about any background sounds. Thus, it has been found that with enough dataset variance, periodicity or other repetition is irrelevant for the presently used separator. To accomplish this, the separator used herein has a separator model such as a neural network that is mask-based. A mask is an estimate of the waveform (or profile or signature) of an audio signal of a single audio source or a single channel to be output by the separator. As used herein, the form of such a mask may be a matrix with the same shape as an input mixed source spectrogram. When the values of the mask matrix are binary, this is referred to as a hard mask, while a soft mask may have a matrix with a range of values such as from 0.0 to 1.0. The mask may be element-wise multiplied to (or otherwise combined with) the mixed source spectrogram data to produce a separate source estimate (also referred to herein as a separated source audio signal or just source audio signal data). Thus, the separator learns the noise background signatures and the target source or drone signature, and removes or separates the target source signature from the background signatures. This results in a “boost” of the target source signature (in terms of signal-to-noise ratio measured in dB) for better detection by the classification model. Thus, the separator may output at least a separated single signal (or mask) for a target audio source, such as a drone. By one form, the separator model also may output a single audio signal for all background signals combined. Alternatively, or additionally, the separator may output a separate signal for each individual background audio source. One or more of the output signals (or masks) then may be provided to the classification model, which may be a classifier neural network, to verify the identity of a target audio source.

This arrangement makes target audio source detection adaptive and scalable for operating in almost any environment. Specifically, the two-stage arrangement of separator and classifier allows for various combinations of different artificial intelligence algorithms since the separator and classifier are independent of each other. Thus, by one alternative form, either or both stages may have a deep learning model and/or a different machine learning model or other algorithm. Depending on the algorithms used, variable modular architecture can be used to operate the separator and classifier, such as field programmable gate arrays (FPGAs) to operate the neural network for Stage 1, and DL accelerator architecture for Stage 2. Many variations are contemplated.

This modular architecture also enables audio capture and/or separator locations that can be remote from the classifier as well as tracking or localization units. Thus, the present method and system supports two or more distributed first stages with multiple audio input sensors which each capture and mask unique background sources based on the pose and alignment of each sensor (or microphone). The masks then can be provided to a remote shared classifier. The opposite may be true as well where a single separator provides separated audio signals to multiple different classifiers that identify different audio sources. Also, the microphones and the separator may be on one or more edge devices, while the classifier may be remote over a wide area network from the edge devices. For target objects moving across an audio pick-up pattern of one or more of the microphones, the two-stage arrangement then also provides improved separation and discrimination of changes in background noise.

By one form, the separation model is trained to provide two masks or mask channels used to generate (1) a separate target (or drone) audio source signal, and (2) a separate background audio source signal, where the background audio source signal may include contributions for one or more background audio sources. In this case, a mask a single background source signal is output from the separator, at least for training, and may include contributions from multiple audio sources such as traffic sounds, people talking, sirens, and other urban sounds as one example. By another example, each different background audio source has its own output mask from the separator model used to generate a corresponding separate background audio source signal. In either of these cases, a target audio source detection system may be provide with a separation model with a selected number of output signals, such as 2 to 5. Generally, the greater the number of output signals from the separator model, the higher the accuracy of the system. Thus, the audio source detection system may provide for a selection of a separator model with a desired number of output signals, and this selection may be performed manually or automatically by the system. In the latter case, a library of separation models each with a different number of output masks may be provided, and the system may select a model depending on a desired accuracy.

By one other approach, multiple separation models may be trained to detect different background noise source environments. Thus, one separation model may be for urban sounds, another model for rural sounds, yet another for industrial sounds, while another is for forests, and so forth. When an audio target source detection system is being provided to a specific user, the user may select a separator model associated with sounds relevant to the environment to be monitored by the system. Otherwise, the system may sense an environment to be monitored and then automatically select a separator model from a library of separator models and trained on relevant sounds. The use of such an environment specific separator model increases the accuracy of detection by reducing the range of variance in the background signals thereby increasing the efficiency in separating background sounds common for a specific environment from the mixed signal.

Such a target audio source detection system also may have the separator and classifier trained to identify different types of target audio sources, such as drones, including different drone models, styles, configurations, and so forth as desired that make different sounds. Thus, stage 1 separators and stage 2 classifiers described herein may be trained to distinguish among different drone signatures. This may be provided on a single separation model and classifier, or multiple models may be provided that are trained for different drones and may be provided in a library as mentioned above for variations in environments and/or amount of output signals at the separator model. The library may have any desired combination of models for different target types, different environments, and/or different number of audio sources.

As mentioned in experiments below, the disclosed stage 1 separator outputs a target audio signal with a sound interference ratio (SIR) that increased by 60 db (140 db versus 80 db) compared to conventional single stage audio source detection system. Also, the boosted signals from the separator model were detected by the second stage classifier with an accuracy of greater than 90% (and with an F1 score greater than 0.9, which indicates a high performance classifier (where over 0.9 is very good, 0.8 to 0.9 is good, 05. to 0.8 is adequate, less than 0.5 is poor) as described in greater detail below.

It will be appreciated that in addition to drones being tracked or navigated, the system and method described herein may be used for audio tracking, sound detection, and/or noise finger printing for other target sounds in noisy environments including for acoustic applications such as for security, surveillance, sound-based machine health monitoring, musical analysis and enhancement, and so forth.

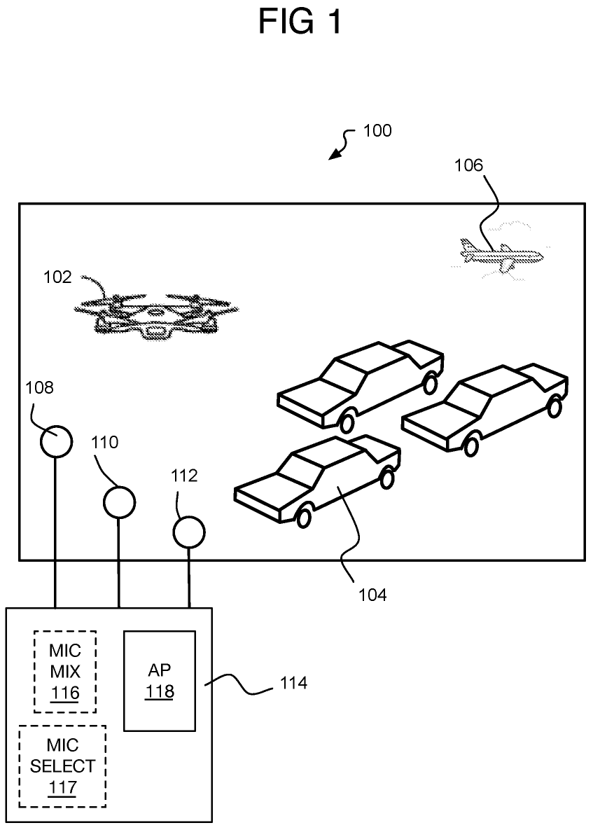

Referring to FIG. 1, an example target audio source detection setup 100 may be a typical environment for using the disclosed system and method described herein. The setup 100 may have a target audio source 102, such as a drone, flying within an environment to be monitored, such as an urban area. The environment 100 may include a first background audio source 104 such as one or more vehicles or traffic generally, and a second background audio source 106, such as an airplane. It will be understood that there may be at least one background audio source, and the number of actual background audio sources is unlimited. By one form, it also will be understood that many different target audio sources and background audio sources may be used, and the audio processing (or source detection) system described herein has no specific limit on the type of audio sources as long as a source separation unit can detect a desired type of target audio source. By one form, any type of detectable audio source can be a target or background audio source as long as a source separation neural network can be trained to detect a desired target audio source and a classifier can identify the desired target audio source.

The target audio source 102 as well as the background audio sources 104 and 106 all may be within a pick-up range of audio sensors (or microphones) 108, 110, and 112. By one form, at least one microphone is present but can be more as shown here. The microphones should be able to accurately capture the target audio signal such as a sound of a drone and so forth such that just about any microphone should be adequate. Thus, there is no other particular limitation to the type or model of microphone that can be used.

The setup 100 also may include a device 114 that has one or more (and here three) microphones 108, 110, and 112 and that provides an audio signal from each microphone 108, 110, and 112 to a microphone mixing unit 116 when multiple microphones are being used. In this case, the mixing unit 116 may be an application or module, which may be in software, that combines audio output from multiple microphones and that outputs a single mixed audio signal (where a mixed audio signal refers to mixing multiple audio signals (or audio signal components) whether from a single microphone or multiple microphones. One or more audio sources may contribute audio signal components to any combination of the multiple microphones. Also, the multiple microphones 108, 110, and 112 may be in a same location so that their pick-up patterns overlap and generally receive the same acoustical waves from the same audio sources, or alternatively, the multiple microphones could be at less overlapping or even completely different locations receiving audio signals from different audio sources, when so desired. In any of these case, the mic mix unit 116, when being used, may combine the signals from multiple microphones and provide a single mixed audio signal to an audio processing (AP) unit 118 (also referred to as a target audio source signal detection unit or just audio source detection unit) that performs audio source detection. Otherwise, when the device 114 has only a single microphone, or when a single audio signal is selected from multiple microphones, then the mic mix unit 116 may be omitted, and the single mixed audio signal may be provided to the AP unit 118. It should be noted that when multiple microphones are each providing a mixed audio signal and only one of the mixed audio signals may be selected for audio source detection, the selection may depend on amount and/or variance of noise, or some other criteria for example, and such selection may be performed by a mic selector unit 117.

The target AP unit 118 may be wirelessly coupled or coupled by wire to the one or more microphones 108, 110, and/or 112. Thus, the device 114 and the AP unit 118 may be on the same device as the microphones or may be remote from each other. The microphones 108, 110, and/or 112 may be on an edge device, such as on stand-alone microphones or microphones on surveillance devices such as on cameras or networks of cameras. Otherwise, the microphones can be on any mobile device including smart phones, tablets, laptops and so forth. The AP unit 118 may be remote from the microphones, mic mix unit 116, and/or mic select unit 117, and at a location over a wide area network (WAN), website, or internet (or cloud) server.

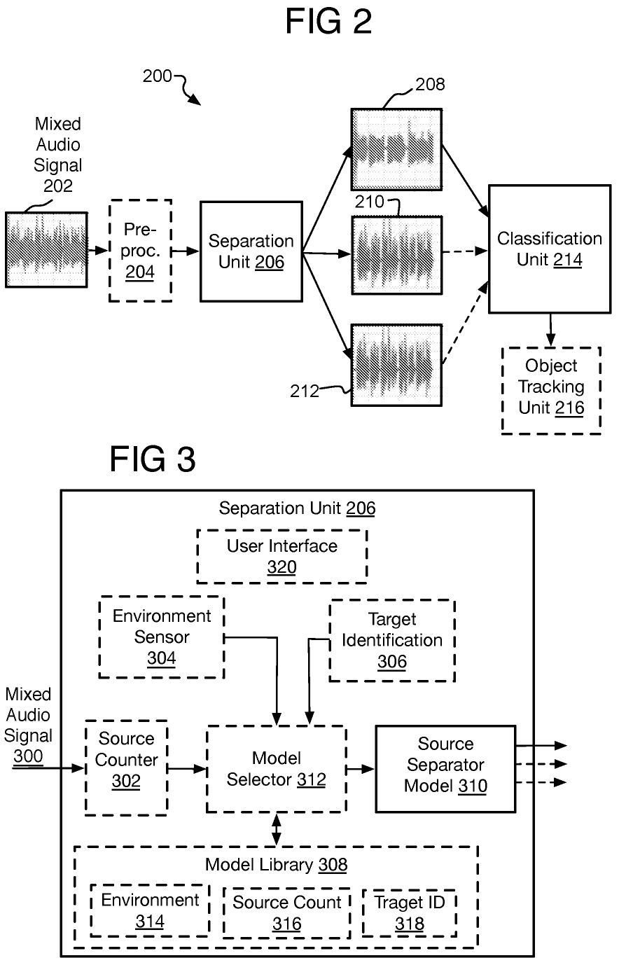

Referring to FIG. 2, the audio processing unit 118 may be, or have, a target audio source detection system or device 200. The system 200 may receive a mixed audio signal 202 with components from multiple audio sources as described above. The system 200 also may have an optional pre-processing unit 204 and a first stage audio detection separation unit 206 that outputs at least a separated target audio signal 208, but also may output one or more, and here being two, separated background audio signals 210 and 212 as desired. At least the separated target audio signal, but also the background audio signals 210 and 212 when present, may be input to a second stage classification unit 214. The resulting classification or confirmed identification of the target audio signal then may be provided to an object tracking (or localization) unit 216 to locate and track the target audio source, or to other audio processing applications as desired.

In more detail, either the microphones or devices with the microphones, and/or a separate pre-processing unit 204, may be provided to perform pre-processing to enhance and/or format the mixed audio signal to be input to the separation (or separator) unit 206 as desired. This may include analog to digital conversion (ADC), or dividing the audio signal into samples at a certain sampling rate such as with a sound source captured at audio frequency (16-44.1 Khz).

Otherwise, no other pre-processing is required, although other pre-processing could include acoustic echo cancellation (AEC), denoising, dereverberation, automatic gain control (AGC), dynamic range compression, equalization, and so forth as desired.

By some options, the pre-processing also may include converting the time domain data of the mixed audio signal into frequency domain data, such as frequency or magnitude spectrums. Alternatively, however, this is not needed and neural network structure described below performs its own domain conversions. Whether or not the pre-processing was performed, the mixed audio signal then may be provided to the separation unit 206.

Referring to FIG. 3, the separation unit 206 may have a source separator model (or just separator model) 310 that converts the input mixed audio signal into separate audio signals as well as an optional model library 308 and other units that can be used to select a model from a library of multiple different separator models. Specifically, different separation models may be made available and that are trained to detect specific types of audio sources. Thus, as introduced above, some models may be environment models 314 that each may be provided for a different environment or combination of environments, such as rural, suburb, urban, industrial area, commercial area, forest, mountains, desert, inland water, wetlands, at sea, sea shore, military zone, and so forth, as well as time of the day, weather conditions, season, and so forth. Source count models 316 may be specific to a certain number of separate output background audio signals, such as having a different model each for 1 to 5 background audio signal outputs. Also, different target ID models 318 can be used to separate a target audio signal of a different target audio source when multiple different types of target audio sources are being detected. For example, a number of models may be provided in library 308 for different types of drones as a target audio source. In this case, a model 318 for the desired specific type of drone then may be selected to increase efficiency of the system 200 and accuracy (with reduced noise for example) of the output separate audio signal. This may include different separator models for different drone styles, brands, and/or construction such as different motors, propellers, or propeller arrangements, and so forth of a target audio source and is not particularly limited. Also, by one approach, a single separator model may be trained for detection of multiple different targets.

By one form, more than one of these available variations in separator models can be provided, and by one alternative form, any combination of the available model variations can be provided. Thus, the library 308 may provide a model for a certain environment (urban, rural, or other), each for a number of total different separate audio signal outputs (here being 2 to 6), and each for a different target audio source available for the models. Thus, for example, if there are two different environments available, with five different output number settings, and three different target types, such as three different drones, then (2×5×3=) 30 different models may be available. Again, this can be provided in any desired combination of the available models.

These selections may be implemented in a number of different ways. By one form, a user's preferences may be known before a setting up of the system 200 by a user or at a user's location, and the system 200 may be provided with the desired selected model without the need to provide access to a library 308 or the need to have the entire library with the system 200 at a user's device. Such a library may be modified in the future by providing at least part of the library in firmware or software. Otherwise, the library 308 may be provided with the separation unit 206 either locally with those components of system 200 and separation unit 206 that are located at a user's location, or may be accessible remotely over a WAN or other computer or communications network and at a remote or cloud server for example. The library 308 may be located locally with, or remote from, any of the other components or units of the system 200 as is desired as long as a selected model for use and from the library 308 can be used by the source separator model unit 310 to separate audio signals. By one form, a user interface 320 may be provided so that a user can select a model to use among the available models at the library 308, and such interface may have many different arrangements and forms, such as a list of models that can selected on a visual display on a computing device screen. Many variations are contemplated.

By another alternative, the separation unit 206 may have units to perform automatic detection of characteristics of the acoustic setup so that a model selector unit (or just selector) 312 may automatically select an appropriate separation model from the library 308. Thus, the separation unit 206 also may have a source counter unit 302, an environment sensor unit 304, a target identification unit 306. When the output of the source separator model 310 is to only be two separate audio signals, one for the target audio signal and one background audio signal that includes all background audio signals from all background audio sources, the source counter may or may not be needed. Otherwise, for these examples, the source counter unit 302, receiving mixed audio signal 300, may be provide when the source separator model 310 is trained to attempt to output separate background audio signals for different audio sources. The source counter unit 302 may use machine learning (ML) or deep learning (DL) neural networks to determine the number of audio sources that appear to be present in the input mixed audio signal. The number of detected audio signals then may be provided to the selector 312, which then may select a model with the same number of background audio source signals. Otherwise, the source counter 302 may provide a count that is a maximum number of background audio signals when the source counter unit 302 detected more audio sources than the maximum number of background audio signal outputs for the available model.

Instead, or in addition, an environment sensor unit 304 may be provided to detect the environment being monitored, such as to detect whether the environment is urban, rural, or some other specific environment mentioned above. This may be accomplished by using sensors such as visual detection with cameras for example that can be used with object recognition software, a course audio analysis of audio signals from the microphones that classifies certain sounds such as in a single stage, or other sensors including a global positioning system (GPS), thermometer, hygrometer, altimeter, and so forth. Otherwise, the environment may be detected by analyzing the mixed audio signal for variance, magnitude, frequency bandwidth, spectrum, etc. By one form herein, environment detection may be performed using the same mixed signal audio inputs used for the audio source detection and finding a best match to known environments using pre-trained neural networks. Greater accuracy and performance on a geographical basis can be accomplished by reinforcement learning of the audio source detection neural network herein using local environment sounds and GPS location to emphasize unique audio signatures in a specific vicinity. An indicator of the detected environment then may be provided to the selector 312, whether alone, or in addition to one or more of the other indicators.

Similarly, if not already selected manually, the target identification unit 306 may detect which target or targets, among multiple possible targets used for training the source separator models 310, is being detected. This may be accomplished by using user input. When a certain target (or target type) is being detected, the target identification unit 306 then may provide a target indicator to the model selector 312 to select the appropriate model that is trained to separate the signal of the detected target and selected from the library 308. Any one or combination of these indicators may be provided to the selector 312 and then used to select a single separator model for the separation. Alternatively, use of multiple separation units 206 each with a different source separator model 310 is explained below.

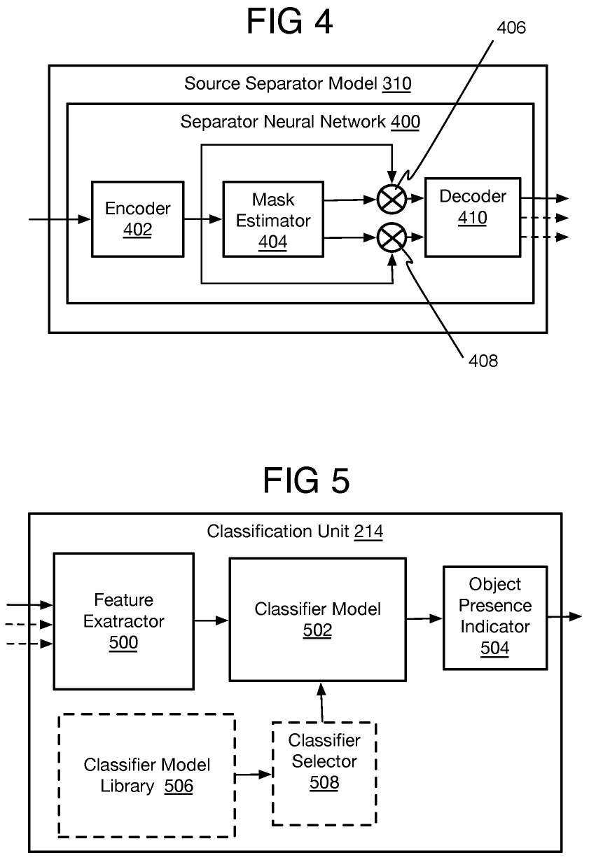

Referring to FIG. 4, the source separator model 310 may be a number of different neural networks or algorithms. In the present example, the source separator model 310 has a mask-based separator neural network (NN) 400 with three stages: an encoder 402, a mask estimator 404, and a decoder 410. The encoder 402 encodes the input mixed audio signal into an intermediate format (or features) expected by the mask estimator 404. By one example, the encoder 402 has convolutional layers that convert the time domain data of the input (and pre-processed) mixed audio signal into the intermediate values that represent a magnitude spectrum or spectrogram (with values in dB) in a frequency domain and expected by the mask estimator 404. The mask estimator 404 then outputs at least one target mask. By one form, the separator also outputs, or has the ability to output, at least one background mask. By one form, only one target mask is output and a single background mask is output that represents all background audio signals combined. By another alternative, multiple background masks are output, each of a different background audio source. The masks then may be multiplied by, or otherwise combined with, the encoded mixed audio signal at combiners (or multipliers) 406 and 408 respectively, or in other words, a frequency domain spectrogram of the input mixed audio signal. The multiplication forms separate but intermediate (frequency domain) target and background audio signals. The decoder then transforms the intermediate separate signal representations to time-domain separated speech signals using transposed convolutional layers as well. The details of the encoder 402, separator neural network 400, and decoder 410 are provided below.

Referring to FIG. 5, the classification unit 214 receives a separated audio signal, one individual signal at a time, and from the source separator model 310 to then classify the audio signal by providing a confidence value. By one example form, the confidence value indicates how close the separated audio signal is to a known or ground-truth audio signal signature at least of a target audio source, but also of other background audio sources when desired. The classification unit 214 may use many different models. By one form, the classification unit 214 has a feature extractor 500, a classifier model 502, and an object presence indicator unit 504. The feature extractor 500 in this example may be a chroma feature extractor that converts the audio signal into a frequency domain and into Mel frequencies for example. Other alternatives could be used instead. The object presence indicator 504 may compare the classifier output, such as a confidence value for an audio source, to a threshold to verify the identification of the audio source, and/or otherwise may merely provide the output from the classifier model in a desired format, for example .WAV or pulse code modulation (PCM), to be provided to other applications. This may include a target audio source indicator in a certain bit depth for example, and that may be a numerical value, whether binary or from a range of values, and from the classifier indicating the confidence of prediction of the specific sound source, which it is associated with during training. The input for a tracking application then may be relevant audio wav/PCM data related to the detected target audio source of interest. Either separated or original captured audio may be used.

By one example, the classifier model 502 is a YAMNet neural network with MobileNetV1 architecture, or other neural network with blocks of depthwise layers and pointwise layers alternating with batch normalization layers. More details are provided below. The output confidence value of a separated audio signal may be compared to a threshold to determine if it is to be considered an audio signal of a target audio source and/or specific background audio source when desired and particularly for training the network.

By one form, the classification unit 214 also has a classifier model library 506 with multiple classifier models, where each model may be used to classify different target or background noises, and the most relevant classifier model may be selected manually for use by a user at an interface for example. Instead, the classifier model may be selected automatically by a classifier selector unit 508 with sensors as described above for the separation unit 206. Alternatively, and as described below, more than one classifier model may be used with a single separation unit and at the same time.

Referring again to FIG. 2 as an optional third stage, and when a separated audio signal output yields high confidence as a target audio signal of a target audio source, an object tracking unit 216 may be provided to determine sound source localization (SSL). The object tracking unit 216 may be one or more ML and/or AL networks, models, or other algorithms trained to estimate a target's relative position, speed, and direction.

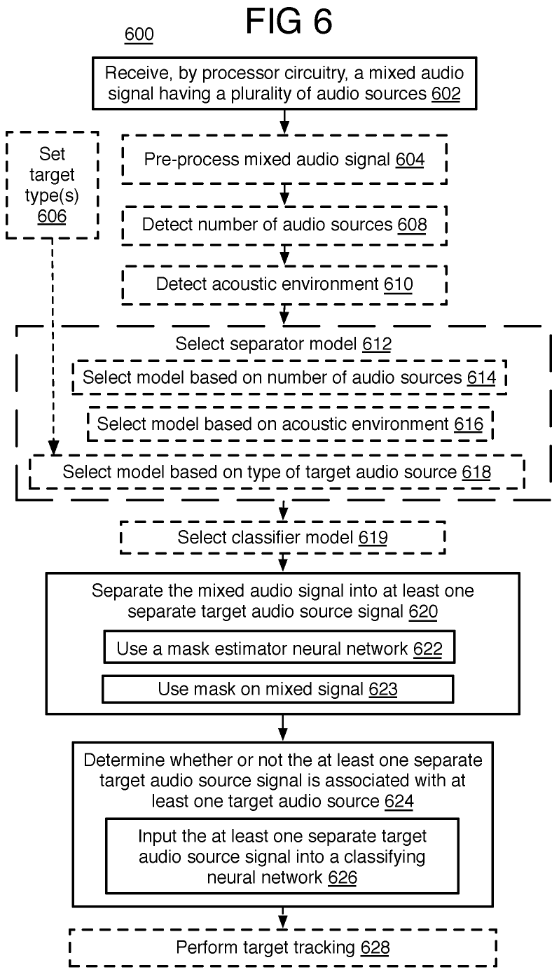

Referring to FIG. 6, an example process 600 for a computer-implemented method of audio detection of a target audio source in a noisy environment is provided. In the illustrated implementation, process 600 may include one or more operations, functions, or actions as illustrated by one or more of operations 602 to 628, generally numbered evenly. By way of non-limiting example, process 600 may be described herein with reference to example setups, systems, units, or neural networks 100, 200, 700, 800, 900, 1000, 1100, 1200, and 1300 described herein with FIGS. 1-5, and 7-13, or any of the other setups, systems, processes, or networks described herein, and where relevant.

Process 600 may include “receive, by at least one processor, a mixed audio signal of a plurality of audio sources” 602. As described above, the mixed audio signal may have a target audio signal contribution and one or more background audio signal contributions as in the real world. The target audio signal may originate from a target audio source such as a UAV, drone, or other transport, vehicle, animal such as bees for example, or other moving object also as described above. The background noises may be traffic, airplanes, baby crying, or any other noise as described above. The audio signals, or specifically acoustic waves, may be captured by one or more microphones as long as a single mixed audio signal is provided to a separation unit.

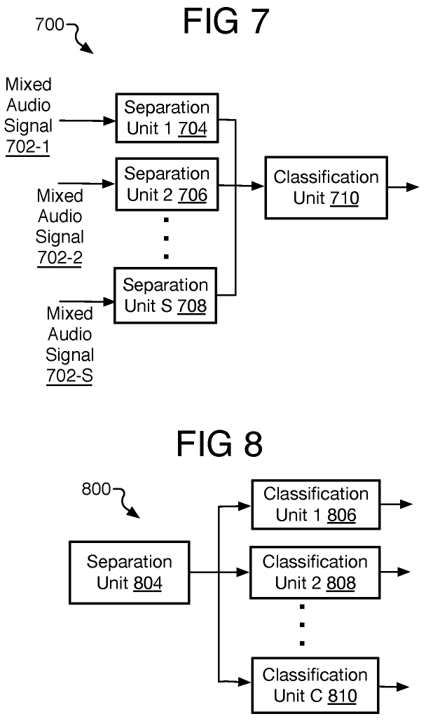

Referring to FIG. 7 for one example alternative approach, a setup or system 700 has multiple separation units 1 to S (704 to 708 numbered evenly) each respectively receiving a mixed audio signal 702-1 to 702-S. Each separation unit 704 to 708 may be trained to separate audio signals of at least some different audio sources. Thus, the target audio source(s), background source(s), or both may be different from separation unit to separation unit 704 to 708. By one form, all of the separation units are at or are associated with microphones in a same geographical area and receive a mixed audio signal (or just mixed signa) with the same audio sources. By an alternative example, the geographical area associated with each separation unit may overlap but is not the same, or may be entirely different areas such that the individual separation units 704 to 708 each may receive a mixed signal with different audio sources. By one form, the multiple separation units 704 to 708 provide output of separated audio signals to the same classification unit 710 trained to classify audio signals of audio sources from any of the separation units. By another alternative, the individual separation units 704 to 708 each has its own classification unit 710 trained to identify the specific audio sources for a single one of the separation units. The following audio detection operations will assume just a single separation unit and a single classification unit unless mentioned otherwise.

Process 600 may include “pre-process mixed audio signal” 604. This may include ADC or any other pre-classification that is desired. As mentioned, the pre-processing can include conversion to the frequency domain, such as by fast Fourier transform (FFT) or other conversions when desired. In the present example, however, the neural networks described below receive input to the separation unit and classification unit in a time domain during a run-time and internally convert the time domain data to frequency domain spectrum data. For the present examples, the mixed audio signal input to the separation unit may be sampled at 44.1 kHz for samples (or frames) with a duration of 30 to 60 seconds.

Process 600 optionally may include “set target type(s)” 606 when more than one separation model and each or individual models are trained to detect a different one or more target audio sources, such as a different drone by one example. The separation models may be provide in a library and may be available for automatic or manual selection as described above and after deployment of the audio detection device or system. Otherwise, such selection may be made before such deployment and the library may or may not be available to an end user.

Likewise, process 600 optionally may include “detect number of audio sources” 608, where multiple separation models in the library may be trained for a different number of audio sources to separate. The following is pseudo code of one example audio source counter that can be used and that counts the number of audio sources detected in a mixed audio signal. This counter is neural network based, although other types of counters could be used. See openvuPytorch https://github.com/Piteryo/SpeakerCount.

```
Audio CRNN (convolutional recurrent neural network):
(
  (spec): MelspectrogramStretch(num_mels=128, fft_length=2048, norm=spec_whiten,
stretch_param=[0.4, 0.4])
  (net): ModuleDict(
    (convs): Sequential(
      (0): Conv2d(1, 32, kernel_size=(3, 3), stride=(1, 1), padding=[0, 0])
      (1): BatchNorm2d(32, eps=1e−05, momentum=0.1, affine=True, track_running_stats=True)
      (2): ELU(alpha=1.0)
      (3): MaxPool2d(kernel_size=3, stride=3, padding=0, dilation=1, ceil_mode=False)
      (4): Dropout(p=0.1)
      (5): Conv2d(32, 64, kernel_size=(3, 3), stride=(1, 1), padding=[0, 0])
      (6): BatchNorm2d(64, eps=1e−05, momentum=0.1, affine=True, track_running_stats=True)
      (7): ELU(alpha=1.0)
      (8): MaxPool2d(kernel_size=4, stride=4, padding=0, dilation=1, ceil_mode=False)
      (9): Dropout(p=0.1)
      (10): Conv2d(64, 64, kernel_size=(3, 3), stride=(1, 1), padding=[0, 0])
      (11): BatchNorm2d(64, eps=1e−05, momentum=0.1, affine=True, track_running_stats=True)
      (12): ELU(alpha=1.0)
      (13): MaxPool2d(kernel_size=4, stride=4, padding=0, dilation=1, ceil_mode=False)
      (14): Dropout(p=0.1)
    )
    (recur): LSTM(128, 64, num_layers=2)
    (dense): Sequential(
      (0): Dropout(p=0.3)
      (1): BatchNorm1d(64, eps=1e−05, momentum=0.1, affine=True, track_running_stats=True)
      (2): Linear(in_features=64, out_features=4, bias=True)
    )
  )
)
```

The outputs are confidence scores (0 to N) each for an available number of sources. By one form, the counter can count up to 4, 5, or 6 total audio sources including the target audio source(s). If there are more audio sources present than can be counted, the counter will provide the highest confidence for the highest available count. This approach can be pipelined such that a downfiltering can be accomplished using multiple neural network filters which successively remove irrelevant audio sources, thereby improving the final output score.

As yet another option, process 600 may include “detect acoustic environment” 610, where multiple separation models in the library may be trained for a different environment, such as rural, urban, or the other environments mentioned above. By one form, a user may select a model with an appropriate environment and no detection of the environment is needed. By another form, an audio source detection system may automatically detect the environment by using sensors as described above.

Process 600 then may include “select separator model” 612, which may include any one or more of: “select model based on number of audio sources” 614, “select model based on acoustic environment” 616, and/or “select model based on type of target audio source” 618, as well as for any other desired combination or variance.

For the count, the separation models may be provided for 2 to 4, 2 to 5, or 2 to 6 total audio sources including both the target and background audio sources. So for example, when up to 4 outputs from a separation model is available, three different models with 2, 3, and 4 outputs respectively may be provided in the library.

The audio detection system may have any combination of environment, count, and/or target type separation models available, and may or may not be available to an end user in a library. Thus, only one variation (or environment, count, or target type) may be available, any two, or all three, or others that could be used as well. The models also may be combined into single models, such that each separation model is provided for a possible variation combination. Thus, when all three variations of environment, count, and target type are provided, one separation model provides a specific environment, count, and target type, and this may be different (in at least one of the variations) from model to model, and by one form, each possible combination is provided in the library or is otherwise available.

Also, multiple separation models may be selected and used to compare the results and then use the best results among the compared results, or the results from multiple models may be otherwise combined as desired to obtain better results.

Process 600 optionally may include “select classifier model” 619, where multiple different classifier models are also available, and where a classifier model is trained on different audio sources as with the separation models. By one form, the classifier selection is automatic where a classifier is selected that is trained in the same audio sources as a selected separation unit. As with the separation, at least one classifier model may be selected for operation, and multiple selected models may be used when desired.

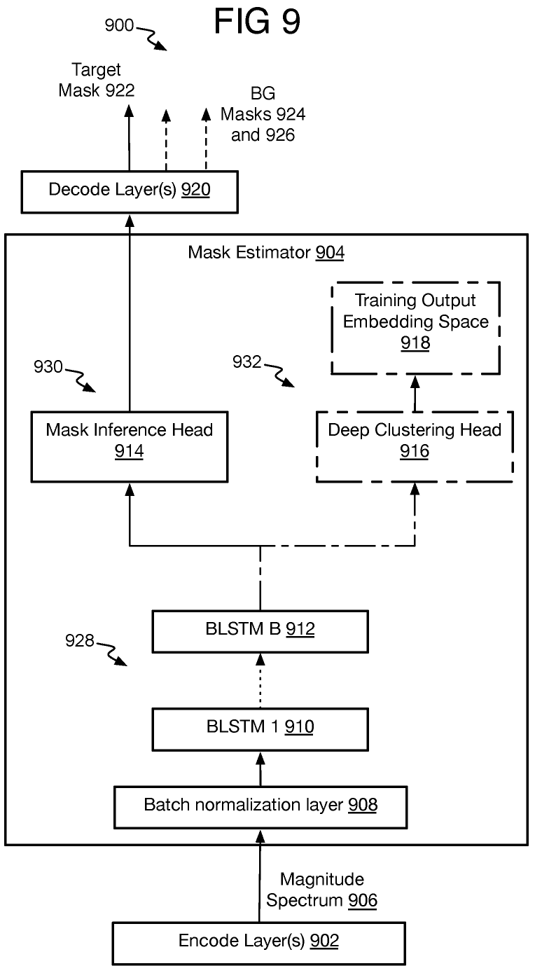

Referring to FIG. 8 for another example, a setup or system 800 has multiple classifier units 1 to C (806 to 810 numbered evenly) where different locations with a classifier may be used to monitor for audio signals of different audio sources, and while monitoring the same location with a single separation unit 804.

For a first stage of the at least two stages for audio source detection used herein, process 600 may include “separate the mixed audio signal into at least one target audio source signal” 620, and this operation may include “use a mask estimator neural network” 622. Specifically, a Chimera type of neural network may be used that performs both mask inferencing and deep clustering in a single network structure that shares at least some of the neural network layers.

Referring to FIG. 9 for one example, a separator neural network 900 has an encoder or encode layer(s) block 902, a mask estimator 904, and a decoder or decode layer(s) block 920. The encoder 902 may have one or more convolutional layers that convert the time domain input mixed audio signal data into a magnitude spectrum 906, while the decoder 920 has one or more transposed convolutional layers to reverse the conversion.

The mask estimator has a shared sequence (or trunk) 928 of layers before a mask interference branch 930 and a deep clustering branch 932. The shared sequence 928 may have a batch normalization unit 908 and bidirectional long short-term memory (BLSTM) layers or blocks 1 to B (910 to 912), where in one example, B is two, but could be four or other desired amount, and as shared recurrent layers for the network 900. This gives the network 900 twice as many trainable parameters as a single direction neural network and including one set going forward in time and another going backward in time. A dropout of 30% zeroing probability is applied to the first three BLSTM layers, which may be dropout layers between the BLSTM blocks or layers.

The mask interference branch 930 has at least a mask interference head 914 that may be a fully connected (FC) linear layer 914 and that converts the output of the last BLSTM block B 910 into the shape of a modified magnitude spectrogram that is a mask. The FC linear layer 914 may use sigmoid or SoftMax activation.

Likewise, the deep clustering branch 932 may have a deep clustering head 916 that also may be a fully connected layer using sigmoid or SoftMax activation. The output of the fully connected layer is a training output embedded space 918 where two dimensions are time x frequency which forms TF representations or bins, and the third dimensions is a D-embedding dimension, where each dimension unit D is for a difference dominant audio source. By one form, the deep clustering is only used during training and is not used during a run-time as suggested by the broken lines on FIG. 9.

As to the parameters for operating the separation neural network, this involved 1066 files trained, with 200 features in a hidden state, by one form with two RNNs (two BLSTM blocks). An epoch length of 1000 may be used, with a batchsize of 10 channels, trained by using MaxEpochs of 100 and a learning rate of 1e-2.

The following pseudo code shows the further parameters of the separation neural network:

```
SEPARATOR MODEL:
SeparationModel(
  (layers): ModuleDict(
    (log_spectrogram): AmplitudeToDB( )
    (normalization): BatchNorm(
      (batch_norm): BatchNorm1d(1, eps=1e−05, momentum=0.1,
        affine=True, track_running_stats=True)
    )
    (recurrent_stack): RecurrentStack(
      (rnn): LSTM(257, 200, num_layers=2, batch_first=True,
      bidirectional=True)
    )
    (embedding): Embedding(
      (linear): Linear(in_features=400, out_features=5140, bias=True)
    )
    (mask): Embedding(
      (linear): Linear(in_features=400, out_features=771, bias=True)
    )
    (estimates): Mask( )
  )
)
Number of parameters: 4067913
```

See, the Nussl library: E. Manilow, et al., “The Northwestern University Source Separation Library”, Proceedings of the 19^{th} Int'l Society of Music Information Retrieval Conference (ISMIR), Paris, France (2018).

The result is a hard or soft mask or mask matrix with the same shape as an input mixed source spectrogram. The decoder 920 then converts the output frequency domain spectrum mask from the mask estimator into the time domain. The decoder 920 may output just a target mask 922 for a target audio source channel during a run-time. During training, background masks 924 and 926 may be output for one or more background audio source channels, although such background channels could be provided during a run-time when desired.

Thereafter, process 600 may include “use mask on mixed signal” 623. By this example, the mask may be element-wise multiplied to (or otherwise combined with) data of an input mixed source spectrogram from the encoder to produce a separate source estimate (also referred to herein as the separated source audio signal or just source audio signal data).

In correspondence to which masks are output from the separator neural network 900, during a run-time, the separation unit may only output a single separate target audio source output or channel (or multiple separate target audio source channels), without outputting separate background audio source signals. By one form, the separate background audio source signals are also output from the separation unit at least during training in order to evaluate the separation neural network.

In the second stage of the audio detection, process 600 may include “determine whether or not the at least one separate source target audio signal is associated with at least one target audio source” 624. There are many different algorithms, machine learning, and/or deep learning techniques that may be used as the classifier. In the present case, process 600 may include “input the at least one target audio source signal into a classifying neural network” 626.

A YAMNet type of neural network with a MobileNetV1 depthwise-separable convolution architecture may be used as the classifier neural network. By one example, the network was trained as described below to output only two classes including drone and background. No specific identification of different backgrounds was performed in this example. By other alternatives, classifiers can be used that do identify specific background audio sources when so desired.

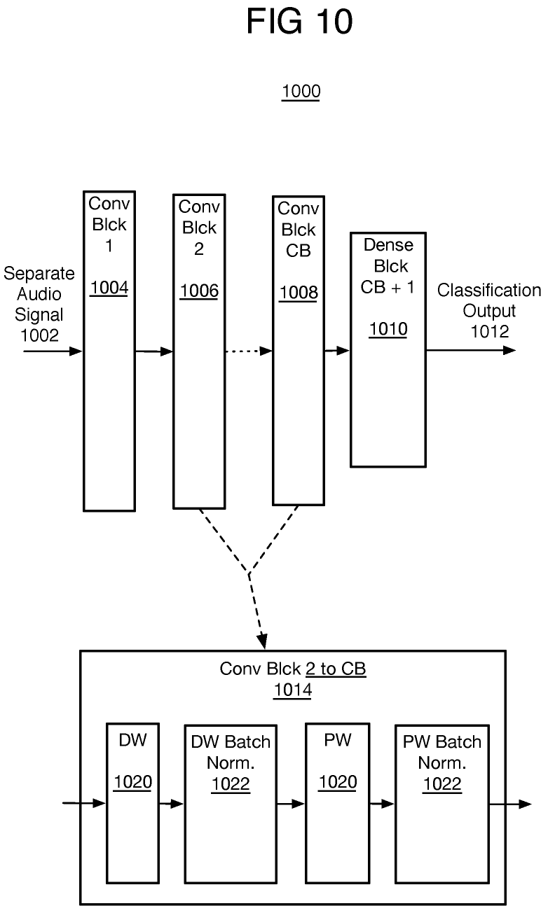

Referring to FIG. 10 for a specific example of classifier neural network that can be used, a classifying neural network (classifying NN) 1000 may receive a separate audio signal 1002 to be classified or have its audio source identified. The signal 1002 may be input to a first convolutional block 1 (1004). Either a preliminary convolution block or block 1 may convert the time domain audio signal into a frequency domain spectrum, and particularly into Mel spectrum features, if not already performed by a feature extractor as described above, or by other pre-processing. The convolutional block 1 (1004) may include two convolutional layers where the pseudo code may be shown as:

layer1/conv/kernel:0
layer1/conv/

Thereafter, the classifying NN 1000 may have repeating convolutional blocks 2 (1006) to CB (1008), where by one example CB is 14. Each block (2006 to 2008, or here in close up as 2014) has a depthwise layer 2016 followed by a pointwise layer 1020, and particularly with batch normalization layers 2018 and 2022 alternating with the depthwise and pointwise layers 2016 and 2020. Specifically, the depthwise and pointwise layers 2016 and 2020 each have a kernel with weights determined by experimentation, and the depthwise or pointwise batch normalization layers 2018 and 2022 use a beta activation. The example repeating pseudo code may be:

Layers 2 to CB, which here as an example for layer 2:
layer2/depthwise_conv/depthwise_kernel
layer2/depthwise_conv/bn/beta
layer2/pointwise_conv/kernel
layer2/pointwise_conv/bn/beta

The last block CB+1 (1010) in the classifying NN 1000 may be a dense layer with:

dense/kernel
dense/bias
dense/kernel
dense/bias

where the bias may be determined by experimentation during training, and the kernels may be weighted accordingly. The addition of the dense block allows for just two classes including the target and a single background class.

The output (1012) of the classifier also may be a confidence value that the input separate signal originated from a specific audio source, such as a target audio source or drone. By one form, the classifier will have specific output nodes for certain audio sources trained on so a confidence value at a certain output node can be related to a specific type of audio source. Thus, by one example, there may be two nodes, a target output node and a background output node that each receives a confidence value. The confidence value then may be compared to a threshold to determine if the identification of the target or background audio source is verified.

Process 600 may include “perform target tracking” 628. Here, an optional third stage may be provided that tracks the target audio source. A localization model using multi-channel audio can be trained to estimate a drone's relative position, speed, and direction with the separated and classified audio signal from the other stages due to the high level of SNR of the output clean drone audio signal.

It will be appreciated that the process 600 can be performed to detect many different types of target audio sources instead of, or in addition to, drones and UAVs. Such targets can be helicopters or other vehicles or transports, other moving machines, or other moving objects such as animals, including bees for example, or even people.

To train the separator NN, loss may be estimated between the output or estimated spectrogram that is the separated audio signal after applying the mask, and ground-truth spectrogram based on the ideal or pure target and background audio signals to generate a mask inference loss. By one form, the separator NN may be trained to detect a drone sound amidst a wide variety of background signals such as a dog bark, a child's cry, wind sounds, helicopter sounds, people speaking, car horns, ocean waves, and so forth, and by one example, and may be trained on about 300 types of background sounds, although 100 were used for experiments below. By one form, the background sounds may be grouped for the separator NN to output a single background separate from the target or drone audio source to establish at least two or only two separate audio signal output channels.

The datasets for drones also may be obtained from the Nussl library. One dataset is the DroneDetectionThesis (Thesis) dataset with multiple drone files where each drone file is a unique drone. Some drone audio of the dataset has very low volume and poor quality, while the background mostly is true ambiance. Thirty samples of each drone were used in experiments explained below. The dataset data was initially in stereo, and converted to mono. The Thesis dataset data was sampled at 44.1 kHz with 10 second durations. See, https://github.com/Drone-DetectionThesis/Drone-detection-dataset.

Another drone dataset that was used for training in experiments described below was the DroneAudioDataset. This dataset has 1000 files from multiple different drones but recorded for a relatively long flight session. The files are spliced to about 1 second intervals. 1332 samples of each Drone and Background were used, and the drone audio data was provided in mono. The drone data was sampled at 16 kHz with about 1 second durations. The Thesis dataset was resampled to 16 kHz to match the sampling rate of the drone data. See, https://github.com/saraale-madi/DroneAudioDataset.

The background files were random noises as mentioned, and by one form for the experiments below, included 100 different types of backgrounds used in 1000 different combinations with the ideal or pure (or ground-truth) drone sounds. It will be understood that none of the training datasets were limited to repetitive audio as explained above or white noise.

### Experiments 1 to 5

A number of experiments were performed to determine the accuracy of the present method and system and for comparison to other alternatives. The results indicate that the disclosed system and method generate separated target audio signals with very high SNRs and scale-invariant source-to-interference ratio (SI-SNR) in dB, thereby providing a very clean target audio signal for significantly more accurate classification. The results were consistent whether a single catch-all separate background audio signal was generated or multiple separate background audio signals each of a different background audio source was generated.

For the evaluation, the following metrics were analyzed:

SI-SDR: Scale-invariant source-to-distortion ratio. Higher is better.

SI-SIR: Scale-invariant source-to-interference ratio. Higher is better.

SI-SAR: Scale-invariant source-to-artifact ratio. Higher is better.

SD-SDR: Scale-dependent source-to-distortion ratio. Higher is better.

SNR: Signal-to-noise ratio. Higher is better.

SRR: Source-to-rescaled-source ratio. Higher is better.

SI-SDRi: Improvement in SI-SDR over using the mixture as the estimate. Higher is better.

SD-SDRi: Improvement in SD-SDR over using the mixture as the estimate. Higher is better.

SNRi: Improvement in SNR over using the mixture as the estimate. Higher is better.

### Experiment 1: Stage 1 Separator NN

For this test, the stage 1 separator (or separation) model was pre-trained to learn a mask of the individual signals in a mixed signal. The separation model used a mixed audio signal as input and pure or ideal audio signals as ground truth to compare to the output in the training phase.

The stage 1 experiment used nine different DL models based on different architectures with different sets of learning parameters, where the Chimera-based separation model of the disclosed method described above was one of these models. The experiments included various parameter configurations for both Chimera-type NNs and Mask inference NNs alone without any deep clustering. The stage 2 for this experiment was the YAMNet, MobileNetV1 depthwise-separable convolution architecture described above and trained to output a ‘drone’ class and a ‘background’ class, when the output of the classifier was needed.

It was first determined that a higher learning rate worked much better to provide good YAMNet confusion matrices for background estimation, and improved model performance. The learning rate was set at 1e-2.

For a drone data estimate on testing after training on the DroneAudioDataset, and on the unseen (or test) data, the disclosed method yielded the best average performance with an SI-SIR of 140 dB, 15 dB higher than the closest alternative.

For a background data estimate during testing after training with the DroneAudioDataset, the disclosed method yielded the best average performance with an SNRi of about 65 dB.

### Experiment 2: Stage 2 Classifying NN

For stage 2 with the classifier, the separated sound signals were classified with a pre-trained classifier. The performance the stage 2 DL model used for sound classification on the outputs of the different stage 1 models showed that the performance of a stage 1 model directly affected the output of the stage 2 model. The better the drone signal is separated from the noisy background, the higher the probability of its detection, thus increasing the overall accuracy of the pipeline.

The classification model or classifying NN described above was used in the experiments with the two datasets mentioned above. The classes from the datasets included 520 sounds including human voice, lawn mower, helicopter, electrical devices, etc. The architecture was described as above to add a new output layer (for example, the dense block) to create just two classes including the drone and background classes, and while training the classifier model with the drone and background data from DroneAudioDataset.

The training resulted in detection of 1 of the 520 classes with an accuracy of about 80%. Also, with the stage 1 model used for experiments above, best detection accuracy reached about 92% on unseen (or test) data and with F1 scores less than 0.9 after training. An F1 score is an error metric which measures model performance by calculating the harmonic mean of precision and recall for the minority positive class.

### Experiment 3: Conventional Repetitive Separators

For comparison, conventional separator algorithms that assume repetitive background sounds were used and the SNR metrics were determined. So called DSP algorithms or neural networks such as REPET, REPET-SIM, 2D Fourier Transform, and HPSS were tested with the same datasets. DSP methods herein refers to methods that are based on signal processing and not on learning based methods, such as conventional machine learning or deep learning.

This deep learning based approach with conventional NNs was used to learn any noise signature for outdoor deployment environments, without any assumption of the characteristics of the noise. The results were poor MIX-SNR, SNR, and SNRi values that merely reached about 5 dB, or in other words provided very noisy separated audio signals that would result in poor classification. Thus, the signal processing-based approach did not provide satisfactory results because these methods, and algorithms and NN structures, are based on assumptions that background sound is repetitive as explained above. This assumption does not hold true for outdoor sound source separation applications described herein. The two-stage approach provides significantly better performance for sound source discrimination and authentication than traditional DSP (or signal processing) based methods.

Experiment 4: Stage 2 Alone without Separator

The stage 2 classification model was also tested alone without a stage 1 separator and by using the neural networks mentioned above. The metrics were computed using pure drone and background signals and their mixed signal was obtained by combining the two sound sources. The metrics were averaged over 1000 drone (or background) and mixed signals. The results show the performance of this approach has a detection accuracy of about 70-75% versus the higher accuracy of the disclosed two stage method and system of about 92%.

### Experiment 5: Repetitive Separation Plus Disclosed Classification

The DSP based separation described above was also combined with the disclosed classification model to classify the output of the DSP based separation. The best classification accuracy for drone sound detection in this case was about 70% and 50% for background audio sources 50%, which is much lower than the mask estimate-based separation of the disclosed method and system.

Since the traditional audio sound separation methods assume that the background has a repetitive pattern (or repetition in an audio source signal pattern), the background is separated from the foreground by factoring this assumption. In certain cases such as HPSS and RepetSim, a drone sound was considered as repetitive and hence detected as a background signal, hence the accuracies were mis-aligned.

As a result, the disclosed mask estimation method performed sound separation significantly better than traditional digital signal processing methods with a relatively high learning rate, large hidden size, number of layers mentioned above, and epoch length set as described above and that gave a best performance.

As the number of background audio sources are increased that are combined in the background output channel for the two channel separator (N=2), the performance of the N=2 separator decays, and the separator with more channels, such as one output channel per background audio source, the better the results. For example, an N=5 separator is able to correctly identify drones amidst 5 backgrounds 5-10% better than a N=2 separator.

In addition, any one or more of the operations of the process in FIG. 6, may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry.” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

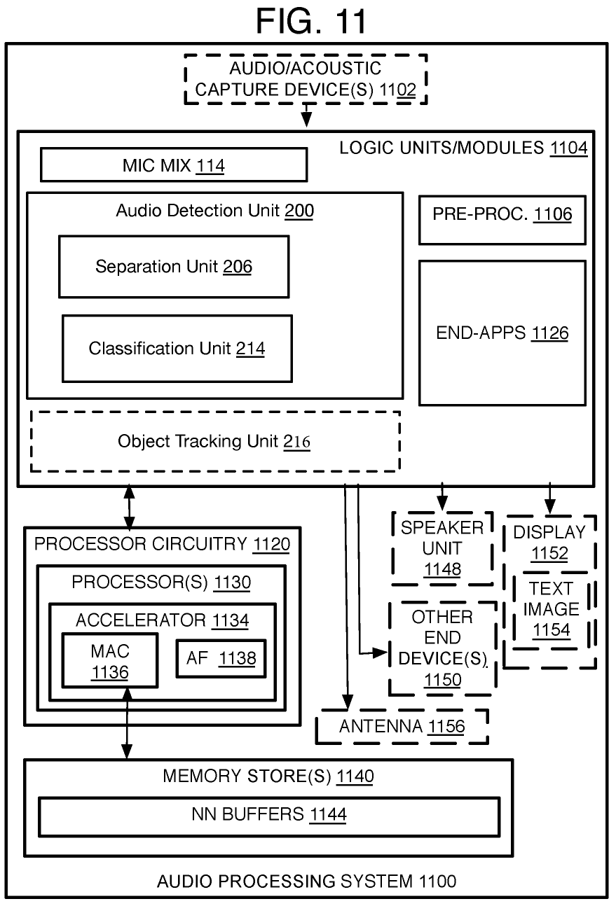

Referring to FIG. 11, an example audio processing system or device 1100 may be, or have, audio processing system 200, and is arranged in accordance with at least some implementations of the present disclosure. In various implementations, the example audio processing system 1100 may have one or more audio capture devices 1102 to form or receive mixed audio signal data. This can be implemented in various ways. Thus, in one form, the audio processing system 1100 is a device, or is on a device, with one or more microphones, and one or a network of the devices 1102 provides the audio signals or data used for target audio source detection, and other audio processing, described above and that may be performed by one of the networked devices 1102. In other examples, the audio processing system 1100 may be in communication with one or a network of microphones, and may be remote from these audio signal capture devices 1102 such that logic modules (or circuits or units) 1104 may communicate remotely with, or otherwise may be communicatively coupled to, the microphones for further processing of the audio signals or data.

In either case, such technology may include a telephone, a smart phone, a tablet, laptop or other computer, other sound recording machine, a mobile device or an on-board device, cloud device, server, or any combination of these. Thus, in one form, audio capture device 1102 may include audio capture hardware including one or more sensors as well as actuator controls. These controls may be part of a sensor module or component for operating the sensor. The sensor component may be part of the audio capture device 1102, or may be part of the logical modules 1104 or both. Such sensor component can be used to convert sound waves into an electrical audio signal. The audio capture device 1102 also may have an A/D converter, other filters, pre-processing units, and so forth to provide a digital signal for audio signal processing.

In the illustrated example, the logic units, modules, or circuitry 1104 may have the mic mix unit 116 and audio detection (or audio processing unit) 200 with at least one separation unit 206 and at least one classification unit 214 as described above with FIGS. 1-8. The logic units (or modules or circuitry) 1104 also may include a pre-processing unit 1106 to handle pre-processing tasks that may be needed at least for the audio processing described herein. An object tracking unit 216 also may be used to track a target audio source also as described above. Otherwise, other end applications 1126 may receive the identified audio signals for further processing as well. Also as described above, the separation unit 206 and classification unit may be on different devices and may communicate over computer networks such as a WAN or the internet to provide separated audio signals from the separation unit 206 to the classification unit 214.

The audio processing system 1100 may have processor circuitry 1120 that forms one or more processors 1130, such as the Intel Atom®, and may include digital signal processors (DSPs) and/or one or more dedicated audio accelerators 1134 that may include firmware and one or more dedicated audio chips. For example, neural network operations of the encoder separator unit 206, or other audio processing, may be offloaded to a Gaussian and neural accelerator (GNA) that has multiply-accumulate circuits (MACs) 1136, activation function (AF) circuits 1138, as well as other circuits, for example.

The system 1100 also may have memory stores 1140 that may have neural network (operation, intermediate data, or layer) buffers 1144 including bias and weight buffers for example. These buffers may hold any neural network related data including inputs, outputs, intermediate features, parameters, and so forth.

The system also optionally may have at least one local or remote communicatively connected speaker unit 1148 to emit audio based on the input audio signals, one or more displays 1152 to provide images 1154 of text, for example, as a visual response to the audio signals, other end device(s) 1150 to perform actions in response to the audio signal, and antenna 1156 to transmit or receive data as needed.

In one example implementation, the audio processing system 1100 may have the audio capture devices 1102, processor circuitry 1120 forming at least one processor 1130 communicatively coupled to the audio capture devices 1102, and memory 1140 communicatively coupled to the processor 1130. The antenna 1156 may be provided to transmit output signals or other relevant commands to other devices that may use the output signals. Otherwise, the results of the output signals may be stored in memory 1140. As illustrated, any of these components may be capable of communication with one another and/or communication with portions of logic modules 1104 and/or audio capture device 1102. Thus, processors 1130 may be communicatively coupled to the audio capture device 1102, the logic modules 1104, and the memory 1140 for operating those components.

Although audio processing system 1100, as shown in FIG. 11, may include one particular set of blocks or actions associated with particular components or modules, these blocks or actions may be associated with different components or modules than the particular component or module illustrated here.

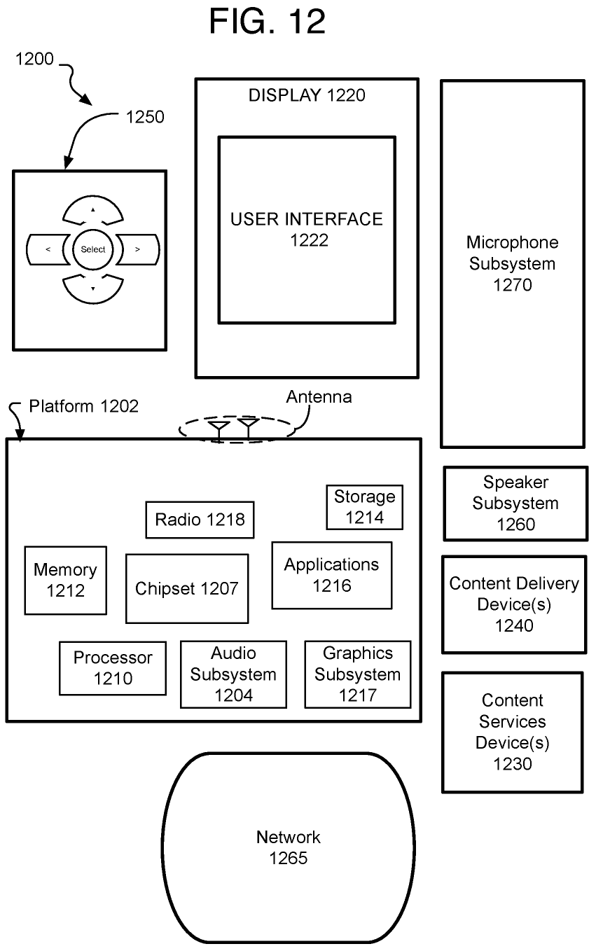

Referring to FIG. 12, an example system 1200 in accordance with the present disclosure operates one or more aspects of the audio processing system described herein. It will be understood from the nature of the system components described below that such components may be associated with, or used to operate, certain part or parts of the audio processing system described above. In various implementations, system 1200 may be a media system although system 1200 is not limited to this context. For example, system 1200 may be incorporated into, or receive acoustic signals or data from, one or multiple microphones, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, servers, and so forth, but otherwise system 1200 may have any acoustic processing device that either has at least one microphone or is receiving mixed audio signal data of one or more (or a network of) microphones to perform any of the audio source detection operations mentioned above.

In various implementations, system 1200 includes a platform 1202 coupled to a display 1220. Platform 1202 may receive content from a content device such as content services device(s) 1230 or content delivery device(s) 1240 or other similar content sources. A navigation controller 1250 including one or more navigation features may be used to interact with, for example, platform 1202, speaker subsystem 1260, microphone subsystem 1270 to provide the acoustic signals or data described above, and/or display 1220. Some of these components are described in greater detail below.

In various implementations, platform 1202 may include any combination of a chipset 1207, processor 1210, memory 1212, storage 1214, audio subsystem 1204, graphics subsystem 1217, applications 1216 and/or radio 1218. Chipset 1207 may provide intercommunication among processor 1210, memory 1212, storage 1214, audio subsystem 1204, graphics subsystem 1217, applications 1216 and/or radio 1218. For example, chipset 1207 may include a storage adapter (not depicted) capable of providing intercommunication with storage 1214.

Processor 1210 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1210 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1214 may include technology to increase the storage performance enhanced protection for valuable digital media when multiple hard drives are included, for example.

Audio subsystem 1204 may perform processing of audio such as acoustic signals to perform the audio detection of target audio sources described herein and then to emit the audio or for other applications such as speech recognition and/or voice recognition. The audio processing techniques described herein may be implemented in various hardware architectures. Thus, the audio subsystem 1204 may comprise one or more processing units, memories, and shared or audio dedicated accelerators, such as a GNA. This may include one or more digital signal processors (DSPs). Such an audio subsystem may be integrated into processor 1210 or chipset 1207. Alternatively, a discrete audio processor may be used. Thus, in some implementations, the audio subsystem 1204 may be a stand-alone card communicatively coupled to chipset 1207. As still another implementation, the audio functions may be provided by a general purpose processor, including a multi-core processor. An interface may be used to communicatively couple the audio subsystem 1204 to a speaker subsystem 1260, microphone subsystem 1270, and/or display 1220. In further implementations, the functions may be implemented in a consumer electronics device.

Graphics subsystem 1217 may perform processing of images such as still or video for display. Alternatively, the graphics subsystem may be used to process audio data described herein. Graphics subsystem 1217 may be a graphics processing unit (GPU) or a visual processing unit (VPU), for example. An analog or digital interface may be used to communicatively couple graphics subsystem 1217 and display 1220. For example, the interface may be any of a High-Definition Multimedia Interface, Display Port, wireless HDMI, and/or wireless HD compliant techniques. Graphics subsystem 1217 may be integrated into processor 1210 or chipset 1207. In some implementations, graphics subsystem 1217 may be a stand-alone card communicatively coupled to chipset 1207.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1218 may operate in accordance with one or more applicable standards in any version.

In various implementations, display 1220 may include any television type monitor or display. Display 1220 may include, for example, a computer display screen, touch screen display, video monitor, television-like device, and/or a television. Display 1220 may be digital and/or analog. In various implementations, display 1220 may be a holographic display. Also, display 1220 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220, speaker subsystem 1260, and microphone subsystem 1270. Platform 1202 and/or content services device(s) 1230 may be coupled to a network 1265 to communicate (e.g., send and/or receive) media information to and from network 1265. Content delivery device(s) 1240 also may be coupled to platform 1202, speaker subsystem 1260, microphone subsystem 1270, and/or to display 1220.

In various implementations, content services device(s) 1230 may include a cable television box, personal computer, network, telephone, Internet enabled devices or appliance capable of delivering digital information and/or content, and any other similar device capable of unidirectionally or bidirectionally communicating content between content providers and platform 1202 and speaker subsystem 1260, microphone subsystem 1270, and/or display 1220, via network 1265 or directly. It will be appreciated that the content may be communicated unidirectionally and/or bidirectionally to and from any one of the components in system 1200 and a content provider via network 1265. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1202 may receive control signals from navigation controller 1250 having one or more navigation features. The navigation features of controller 1250 may be used to interact with user interface 1222, for example. In embodiments, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1204 also may be used to control the motion of articles or selection of commands on the interface 1222.

Movements of the navigation features of controller 1250 may be replicated on a display (e.g., display 1220) by movements of a pointer, cursor, focus ring, or other visual indicators displayed on the display or by audio commands. For example, under the control of software applications 1216, the navigation features located on navigation controller 1250 may be mapped to virtual navigation features displayed on user interface 1222, for example. In implementations, controller 1250 may not be a separate component but may be integrated into platform 1202, speaker subsystem 1260, microphone subsystem 1270, and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example, or by auditory command. Program logic may allow platform 1202 to stream content to media adaptors or other content services device(s) 1230 or content delivery device(s) 1240 even when the platform is turned “off.” In addition, chipset 1207 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 1200 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various implementations, platform 1202, speaker subsystem 1260, microphone subsystem 1270, and/or display 1220 may be an integrated unit. Display 1220, speaker subsystem 1260, and/or microphone subsystem 1270 and content service device(s) 1230 may be integrated, or display 1220, speaker subsystem 1260, and/or microphone subsystem 1270 and content delivery device(s) 1240 may be integrated, for example. These examples are not meant to limit the present disclosure.

In various implementations, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 12.

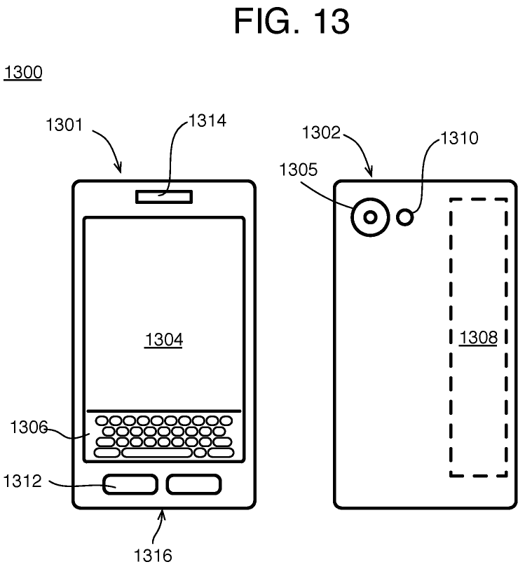

Referring to FIG. 13, a small form factor device 1300 is one example of the varying physical styles or form factors in which system 1100 or 1200 may be embodied. By this approach, device 1300 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system that receives acoustic signals or data from at least one microphone such as a personal computer (PC), server, laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, or smart television), mobile internet device (MID), messaging device, data communication device, speaker system, microphone system or network, and so forth.

Examples of a mobile computing device also may include computers that are arranged to be worn by a person, such as a head-phone, head band, hearing aide, wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The implementations are not limited in this context.

As shown in FIG. 13, device 1300 may include a housing with a front 1301 and a back 1302, a display or screen 1304, an input/output (I/O) device 1306, and an antenna 1308. Device 1300 also may include navigation features 1312. Display 1304 may provide images processed by any suitable display unit for displaying information appropriate for a mobile computing device. I/O device 1306 may include any suitable I/O device for entering information into a mobile computing device. Examples for I/O device 1306 may include an alphanumeric keyboard, a numeric keypad, a touch pad, input keys, buttons, switches, rocker switches, software and so forth. Information also may be entered into device 1300 by way of one or more, or a network, of microphones 1316. Such information may be processed by a separation, classification, and/or localization device as described herein as well as other acoustic mixing devices, speech and/or voice recognition devices, and so forth, as part of the device 1300. By one form, multiple devices 1300 spaced from each may be used to perform the acoustic data collection described above. Device 1300 also may provide audio responses via a speaker 1314 or visual responses via the screen 1304. The implementations are not limited in this context. The housing also may include a camera 1305 and an illuminator 1310.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

In an example 1, a computer-implemented method of audio processing comprises receiving, by processor circuitry, a mixed audio signal having a plurality of audio sources; separating the mixed audio signal into at least one separate target audio source signal; and determining whether or not the at least one separate target audio source signal is associated with at least one target audio source, and comprising inputting the at least one separate target audio source signal into a classifying neural network.

In an example 2, the subject matter of example 1, wherein the target audio source is one of: a moving object that emits a sound, a transport, a vehicle, a drone, an unmanned aerial vehicle, a helicopter, and an animal.

In an example 3, the subject matter of example 1 or 2, wherein the separating comprises separating the mixed audio signal into one separate target source audio signal associated with the target audio source and one background audio signal associated with one or more background audio sources.

In an example 4, the subject matter of example 1 or 2, wherein the separating comprises separating the mixed audio signal into one separate target source audio signal associated with the target audio source and one or more separate background audio signals each associated with a different background audio source.

In an example 5, the subject matter of any one of examples 1 to 4, wherein the separating comprises separating source audio signals of different drones.

In an example 6, the subject matter of any one of examples 1 to 5, wherein the separating comprises inputting mixed audio signal data of the mixed audio signal into an audio signature mask-estimate-based neural network.

In an example 7, the subject matter of example 6, wherein the neural network comprises an encoder, a mask-estimator, and a decoder each having one or more convolutional layers.

In an example 8, the subject matter of any one of examples 1 to 7, wherein the separating comprises a separator neural network having bidirectional long short-term memory (BLSTM) layers shared between a mask interference branch and a deep clustering branch, and at least one mask interference layer on the mask interference branch separate from at least one deep clustering layer on the deep clustering branch, wherein audio signal data input to the separator neural network is in a time domain.

In an example 9, the subject matter of example 8, wherein only the mask interference branch is used during run-time while both the mask interference branch and the deep clustering branch are used during training of the neural network.

In an example 10, the subject matter of any one of examples 1 to 9, wherein the separating comprises using a Chimera type of neural network, and the classifying neural network is a YAMNet type of neural network.

In an example 11, a computer implemented system, comprises memory; processor circuitry communicatively coupled to the memory and being arranged to operate by: receiving, by processor circuitry, a mixed audio signal having a plurality of audio sources; separating the mixed audio signal into at least one separate target audio source signal; and determining whether or not the at least one separate target audio source signal is associated with at least one target audio source, and comprising inputting the at least one separate target audio source signal into a classifying neural network.

In an example 12, the subject matter of example 11, wherein the separating comprises training a separation neural network input with a version of the mixed audio signal and comparing output of the separation neural network to separate ground truth audio source signals.

In an example 13, the subject matter of example 11 or 12, wherein the separating comprises training a separation neural network to receive a version of the mixed audio signal, and wherein the separating and classifying neural networks are trained on data of audio signal signatures regardless of existence of repetition in an audio source signal pattern forming the audio signal signatures.

In an example 14, the subject matter of any one of examples 11 to 14, wherein the processor circuitry is arranged to operate by selecting at least one separating model among multiple separating models to perform the separating, wherein the multiple separating models are individually trained to operate with data of different acoustical environments than others of the multiple separating models.

In an example 15, the subject matter of example 14, wherein the acoustical environments comprise at least rural and urban.

In an example 16, the subject matter of any one of examples 11 to 15, wherein the processor circuitry is arranged to operate by selecting at least one separating model among multiple separating models to perform the separating, wherein the multiple separating models are individually trained to operate with a different number of audio sources.

In an example 17, the subject matter of any one of examples 11 to 16, wherein the classifying neural network is trained to identify two signals comprising a target audio source signal of a single target audio source and a background audio signal of multiple background audio sources.

In an example 18, at least one non-transitory computer readable medium comprising instructions thereon that when executed, cause a computing device to operate by: receiving, by processor circuitry, a mixed audio signal having a plurality of audio sources; separating the mixed audio signal into at least one separate target audio source signal; and determining whether or not the at least one separate target audio source signal is associated with at least one target audio source, and comprising inputting the at least one separate target audio source signal into a classifying neural network.

In an example 19, the subject matter of example 18, wherein the instructions cause the computing device to operate by performing the determining by at least two classifier models remote from each other and trained to identify different target audio sources, different background audio sources, or both.

In an example 20, the subject matter of example 18 or 19, wherein the instructions cause the computing device to operate by performing the separating by at least two separator models remote from each other and trained to separate different target audio sources, different background audio sources, or both.

In a further example, at least one machine readable medium may include a plurality of instructions that in response to being executed on a computing device, causes the computing device to perform a method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

1. A computer-implemented method of audio processing, comprising:
receiving, by processor circuitry, a mixed audio signal having a plurality of audio sources;
separating the mixed audio signal into at least one separate target audio source signal; and
determining whether or not the at least one separate target audio source signal is associated with at least one target audio source, and comprising inputting the at least one separate target audio source signal into a classifying neural network.

2. The method of claim 1, wherein the target audio source is one of: a moving object that emits a sound, a transport, a vehicle, a drone, an unmanned aerial vehicle, a helicopter, and an animal.

3. The method of claim 1, wherein the separating comprises separating the mixed audio signal into one separate target source audio signal associated with the target audio source and one background audio signal associated with one or more background audio sources.

4. The method of claim 1, wherein the separating comprises separating the mixed audio signal into one separate target source audio signal associated with the target audio source and one or more separate background audio signals each associated with a different background audio source.

5. The method of claim 1, wherein the separating comprises separating source audio signals of different drones.

6. The method of claim 1, wherein the separating comprises inputting mixed audio signal data of the mixed audio signal into an audio signature mask-estimate-based neural network.

7. The method of claim 6, wherein the neural network comprises an encoder, a mask-estimator, and a decoder each having one or more convolutional layers.

8. The method of claim 1, wherein the separating comprises a separator neural network having bidirectional long short-term memory (BLSTM) layers shared between a mask interference branch and a deep clustering branch, and at least one mask interference layer on the mask interference branch separate from at least one deep clustering layer on the deep clustering branch, wherein audio signal data input to the separator neural network is in a time domain.

9. The method of claim 8, wherein only the mask interference branch is used during run-time while both the mask interference branch and the deep clustering branch are used during training of the neural network.

10. The method of claim 1, wherein the separating comprises using a Chimera type of neural network, and the classifying neural network is a YAMNet type of neural network.

11. A computer implemented system, comprising:
memory;
processor circuitry communicatively coupled to the memory and being arranged to operate by:
receiving, by processor circuitry, a mixed audio signal having a plurality of audio sources;
separating the mixed audio signal into at least one separate target audio source signal; and
determining whether or not the at least one separate target audio source signal is associated with at least one target audio source, and comprising inputting the at least one separate target audio source signal into a classifying neural network.

12. The system of claim 11, wherein the separating comprises training a separation neural network input with a version of the mixed audio signal and comparing output of the separation neural network to separate ground truth audio source signals.

13. The system of claim 11, wherein the separating comprises training a separation neural network to receive a version of the mixed audio signal, and wherein the separating and classifying neural networks are trained on data of audio signal signatures regardless of existence of repetition in an audio source signal pattern forming the audio signal signatures.

14. The system of claim 11, wherein the processor circuitry is arranged to operate by selecting at least one separating model among multiple separating models to perform the separating, wherein the multiple separating models are individually trained to operate with data of different acoustical environments than others of the multiple separating models.

15. The system of claim 14, wherein the acoustical environments comprise at least rural and urban.

16. The system of claim 11, wherein the processor circuitry is arranged to operate by selecting at least one separating model among multiple separating models to perform the separating, wherein the multiple separating models are individually trained to operate with a different number of audio sources.

17. The system of claim 11, wherein the classifying neural network is trained to identify two signals comprising a target audio source signal of a single target audio source and a background audio signal of multiple background audio sources.

18. At least one non-transitory computer readable medium comprising instructions thereon that when executed, cause a computing device to operate by:
receiving, by processor circuitry, a mixed audio signal having a plurality of audio sources;
separating the mixed audio signal into at least one separate target audio source signal; and
determining whether or not the at least one separate target audio source signal is associated with at least one target audio source, and comprising inputting the at least one separate target audio source signal into a classifying neural network.

19. The medium of claim 18, wherein the instructions cause the computing device to operate by performing the determining by at least two classifier models remote from each other and trained to identify different target audio sources, different background audio sources, or both.

20. The medium of claim 18, wherein the instructions cause the computing device to operate by performing the separating by at least two separator models remote from each other and trained to separate different target audio sources, different background audio sources, or both.
